(19) United States
(12) Patent Application Publication
(10) Pub. No.: US 2009/0013726 A1
(43) Pub. Date: Jan. 15, 2009

(54) GLASS BASE MATERIAL, MANUFACTURING METHOD THEREOF, AND METHOD FOR MANUFACTURING OPTICAL FIBER

(76) Inventor: Mitsukuni Sakashita, Gunma (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/597,686

(22) PCT Filed: May 10, 2005
(86) PCT No.: PCT/JP2005/008540

§ 371 Date: Sep. 9, 2008

(30) Foreign Application Priority Data
May 28, 2004 (JP) 2004-159822
May 28, 2004 (JP) 2004-159848

(51) Int. Cl. C03B 37/02

(52) U.S. Cl. 65/435

(57) ABSTRACT

When forming a taper portion on an end of a glass base material for manufacturing an optical fiber, the taper portion is formed by fusing the glass base material from a modified point after modifying a center-line displacement amount of a fusing point for a center line of the glass base material to a value not more than a predetermined numeric value. Moreover, in a glass base material for drawing having an effective straight base with an average outside diameter D and a taper portion on one end of the effective straight base, when the glass base material is attached to a drawing apparatus, a ratio δ/D between the average outside diameter D and a taper portion distortion δ is δ/D<=0.03, and the taper portion distortion δ is expressed with a maximum value of a center-line displacement amount of the glass base material between an effective straight base end from the taper portion and a distortion evaluating end of the taper portion. In this way, eccentricity of an optical fiber in an early stage of the start of drawing is immediately reduced, and thus the excess length is reduced.

### TECHNICAL FIELD

The present invention relates to a glass base material for manufacturing an optical fiber, a manufacturing method thereof, and a method for manufacturing an optical fiber. More particularly, the present invention relates to a method for manufacturing a glass base material having an end shape suitable for drawing of an optical fiber, a glass base material obtained thereby, and a method for manufacturing an optical fiber using the glass base material.

In addition, the present application also relates to the following applications, the contents of which are incorporated herein by reference for designated countries accepting this reference.

Japanese Patent Application No. 2004-159822 (Application date: May 28, 2004)

Japanese Patent Application No. 2004-159848 (Application date: May 28, 2004)

### BACKGROUND ART

A large-scale glass base material is elongated in an axial direction, particularly, a vertical direction and is divided with predetermined length after being heated in a heating furnace such as an electric furnace, in order to be processed to a glass base material having a diameter suitable for drawing.

FIG. 1 is a schematic diagram showing a glass base material made by elongating a large-scale glass base material in an electric furnace. An elongated glass base material 1 has mechanical cutting faces 2 cut by a face perpendicular to a central axis on its both ends.

As shown in a schematic diagram of FIG. 2, a dummy rod 3 for attaching the glass base material 1 to a drawing apparatus is welded to one end of the manufactured glass base material 1. This portion is gripped. In order to easily perform the start of drawing, the other end is processed in the shape of taper and includes a taper portion 4.

The welding of the dummy rod 3 to one end of the glass base material 1 and the formation of the taper portion 4 on the other end are performed by means of a glass lathe in many cases.

For example, a method for processing a taper shape by means of a glass lathe includes methods disclosed in Patent Documents 1 and 2.

In the glass base material 1 having mechanical cutting faces on its both ends, the dummy rod 3 is connected to the one end and the taper portion 4 is formed on the other end. The glass base material (hereinafter, referred to as “a glass base material for drawing”) having the formed taper portion 4 is attached to a drawing apparatus by making a feeder 5 of the drawing apparatus grip the dummy rod 3 with a scroll chuck 6 as shown in FIG. 3.

Next, the taper portion 4 of the glass base material for drawing is set at a predetermined position of the heating furnace 7 to start to be heated, and a leading end of the glass base material for drawing falls by softening the leading end. After the leading end falls, the leading end is caught and passes through a diameter measurement device 8. After that, when its diameter stably reaches desired wire size, coating and curing to an optical fiber 9 are performed by passing the optical fiber 9 through a first dice 10, a first ultraviolet-ray curing apparatus 11, a second dice 12, and a second ultraviolet-ray curing apparatus 13 in the order. After that, the optical fiber is reeled by a capstan (not shown) in a bobbin via a guide pulley 14.

After that, a drawing process becomes a steady state by gradually raising a feed speed and a drawing speed of the feeder 5 up to a regulation speed. The discrimination for a steady state is performed by whether all of the next indices are satisfied. In other words, index 1: a feed speed and a drawing speed reach a regulation speed, index 2: an outside diameter of the optical fiber is stable, and index 3: the prescribed excess length is withdrawn after the outside diameter of the optical fiber is stable. An optical fiber of a steady part drawn in a steady state is utilized as a product. An optical fiber of an unsteady part drawn in an unsteady state before that is discarded as a faulty part.

Here, the above index 3 is required because eccentricity of the drawn optical fiber is reduced due to the index 3. In the drawn optical fiber, the eccentricity is large in an unsteady part in an early stage of the start of drawing, the eccentricity is gradually reduced with the advance of drawing, and the eccentricity is stable at a certain value in a steady part. Therefore, in the unsteady part, a portion with large eccentricity exists even if the outside diameter satisfies specification. Although this outside diameter is within a specification range, the excess length of index 3 is required to exclude an optical fiber portion with large eccentricity from a product.

FIG. 4A shows the change of outside diameter of an optical fiber to drawing distance and FIG. 4B shows the change of eccentricity of the optical fiber. A point where an outside diameter of the optical fiber is in a specification range is an outside-diameter stable point 16 and a point where eccentricity goes into a specification range is an eccentric stable point 17.

The interval between the outside-diameter stable point 16 and the eccentric stable point 17 becomes the excess length 18 to be excluded. The eccentricity of optical fiber is expressed with an eccentricity ratio defined in the following Expression.

Eccentricity ratio (%)=[(E₀²+E₉₀²)^{1/2}/{(D₀+D₉₀)/2}]*100

In the computation of eccentricity ratio, it is necessary to rotate the optical fiber in an axial direction and measure the profile at two positions of 0° and 90°.

In Expression, E₀ is an amount of eccentricity in 0° and E₉₀ is an amount of eccentricity in 90°. Do is an outside diameter of the optical fiber in 0° and D₉₀ is an outside diameter in 90°.

### [Patent Document 1] Japanese Patent Application Publication 2000-143268

### [Patent Document 2] Japanese Patent Application Publication 2000-203864

### DISCLOSURE OF THE INVENTION

### Problems to be Solved by the Invention

An optical fiber in an unsteady part in an early stage of the start of drawing cannot be used as a product due to eccentricity and thus is discarded. When the discarded optical fiber increases, yield decreases and thus a manufacturing cost increases. Therefore, in order to improve yield, it is necessary to shorten a time in an unsteady part in an early stage of the start of drawing and stabilize quality by realizing a steady state as soon as possible.

In recent years, a glass base material grows in size, in this relation an unsteady part area in an early stage of the start of drawing becomes long, and an amount of the discarded optical fiber also increases. The reason discarding an optical fiber in an unsteady part is that the optical fiber departs from the specification of optical fiber due to the fluctuation of outside diameter, the unevenness of cladding-material, or the like in addition to the above eccentricity. Here, an unsteady part area is shortened and thus yield improves by reducing all or either of values of the above indices.

An object of the present invention is to provide a glass base material having an end shape suitable for drawing, a method for manufacturing the glass base material, and a method for manufacturing an optical fiber, capable of immediately reducing the eccentricity of the optical fiber in an early stage of the start of drawing and of shortening an unsteady part area.

### Means for Achieving the Objects

To solve the problem, according to the first aspect of the present invention, there is provided a method for fusing a cylindrical glass base material and manufacturing a glass base material for drawing having a straight base with a substantially constant diameter and a taper portion that is formed on one end of the straight base and of which a diameter becomes narrow as the taper portion departs from the straight base, the manufacturing method including: modifying a center-line displacement amount of a fusing point for a center line of an effective straight base of the glass base material to a predetermined numeric value to form a modified point; and fusing the glass base material at the modified point to form the taper portion. In this way, distortion of the taper portion formed on the glass base material for drawing becomes smaller than that of the original taper portion, and the excess length generated from the start of drawing to a steady state is shortened.

Moreover, as one embodiment, in the above manufacturing method, the modifying includes an operation heating the glass base material with a burner flame while rotating the glass base material by means of a glass lathe. In this way, a precise modification work can be performed.

Moreover, as another embodiment, in the above manufacturing method, the predetermined numeric value is 2.6 mm.

In this way, an effect modifying the glass base material becomes remarkable, and the taper portion with a little distortion can be formed.

Moreover, as another embodiment, in the above manufacturing method, the fusing includes an operation heating the glass base material with a burner flame. In this way, each work of modifying and fusing can be continuously performed.

Moreover, as another embodiment, in the above manufacturing method, the modified glass base material is attached to a drawing apparatus, and the fusing is performed just before drawing. In this way, each work of modifying, fusing, and drawing can be continuously performed. Moreover, since a series of works can be executed at a short time, an effect of modification does not deteriorate.

Moreover, according to the second aspect of the present invention, there is provided a glass base material for drawing having a cylindrical straight base and a taper portion formed on one end of the straight base so that a diameter becomes narrow as the taper portion departs from the straight base, in which the taper portion is formed by fusing a modified point modified so that a center-line displacement amount for a center line of the whole cylindrical glass base material is less than or equal to a predetermined numeric value. In this glass base material, since the excess length generated from the start of drawing to a steady state is short, use efficiency of a raw material becomes high, and thus the optical fiber can be manufactured at low cost.

Furthermore, according to the third aspect of the present invention, there is provided a glass base material for drawing having an effective straight base with an average outside diameter D and a taper portion that is formed on one end of a straight base that is a part of the effective straight base and of which a diameter becomes narrow as the taper portion departs from the straight base, in which a ratio δ/D between the average outside diameter D and a taper portion distortion δ is δ/D<=0.03 when the glass base material for drawing is attached to a drawing apparatus and when a maximum value of a displacement amount of a center of the taper portion for a center of the taper portion side end in the straight base is the taper portion distortion δ.

In this way, the excess length generated from the start of drawing to a steady state is shortened.

Moreover, as one embodiment, in the above glass base material, the end of the straight base is a part having an outside diameter of a value obtained by multiplying a coefficient β in a range of 0.90 to 1.00 (no dimension) by the average outside diameter D. In this way, a reference when measuring distortion δ of the taper portion is prescribed.

Moreover, as another embodiment, in the above glass base material, a length L_{D} of the taper portion is not less than one time of a mean value D_{M} for outside diameters at three to ten points randomly extracted from the vicinity of center in a longitudinal direction of the glass base material in the range of 30 to 60% of overall length of the glass base material. In this way, the start of drawing from the taper portion becomes easy.

Moreover, as another embodiment, in the above glass base material, the taper portion is formed by fusing or grinding. In this way, the glass base material for drawing is prepared and drawing for manufacturing the optical fiber becomes easy.

Moreover, according to the fourth aspect of the present invention, there is provided a method for manufacturing a glass base material for drawing having a straight base with an average outside diameter D and a taper portion that is formed on one end of the straight base and of which a diameter becomes narrow as the taper portion departs from the straight base, the method including drawing the glass base material for drawing in which a ratio δ/D between the average outside diameter D and a taper portion distortion δ is δ/D<=0.03, when the glass base material for drawing is attached to a drawing apparatus and when a maximum value of a displacement amount of a center of the taper portion for a center of the taper portion side end in the straight base is the taper portion distortion δ. In this way, it is possible to manufacture an optical fiber with a predominant optical characteristic at low cost.

### Effects of the Invention

According to the present invention, it is possible to immediately and stably reduce eccentricity of the optical fiber in an early stage of the start of drawing and shorten an unsteady part area that is a faulty part of a product.

In this way, it is possible to improve yield of the production of optical fiber and contribute to resource saving and reduction of manufacturing cost.

### BRIEF DESCRIPTION OF THE DRAWINGS

FIG. 1 is a schematic diagram showing a glass base material elongated and manufactured in an electric furnace.

FIG. 2 is a schematic diagram showing a glass base material for drawing in which a dummy rod is welded to one end.

FIG. 3 is a schematic diagram showing an outline of a drawing apparatus.

FIG. 4A shows the change of outside diameter of an optical fiber to drawing distance and FIG. 4B shows the change of eccentricity to drawing distance.

FIG. 5 is a schematic diagram explaining distortion 6.

FIG. 6 is a schematic diagram showing a glass base material used for distortion measurement.

FIG. 7A shows the change of outside diameter for a longitudinal direction of a glass base material for drawing and FIG. 7B shows the change of a displacement amount of a center line for the longitudinal direction of the glass base material for drawing.

FIG. 8A shows an outside diameter and a center-line displacement amount of a glass base material before taper formation and FIG. 8B shows a center-line displacement amount of the glass base material after forming the taper portion.

FIG. 9 is a view showing correlativity between a center-line displacement amount of a fusing position and distortion of a fused and formed taper portion.

FIG. 10 is a view showing relation between distortion and excess length.

FIG. 11 is a schematic block diagram showing a formation method of a grinding taper portion by grinding.

FIG. 12 is a schematic block diagram showing a method for modifying a taper portion by grinding.

### REFERENCE NUMERALS

1 glass base material,
2, 19 mechanical cutting face,
3 dummy rod,
4 taper portion,
5 feeder,
6 scroll chuck,
7 heating furnace,
8 diameter measurement device,
9 optical fiber,
10 first dice,
11 first ultraviolet-ray curing apparatus,
12 second dice,
13 second ultraviolet-ray curing apparatus,
14 guide pulley,
16 outside-diameter stable point,
17 eccentric stable point,
18 excess length,
20 fusing taper portion,
21 end of straight base,
22 distortion evaluating end,
23 distortion evaluating area,
24, 25 approximate straight line,
26 rotational grindstone,
27 grinding taper portion

### THE BEST EMBODIMENTS OF THE INVENTION

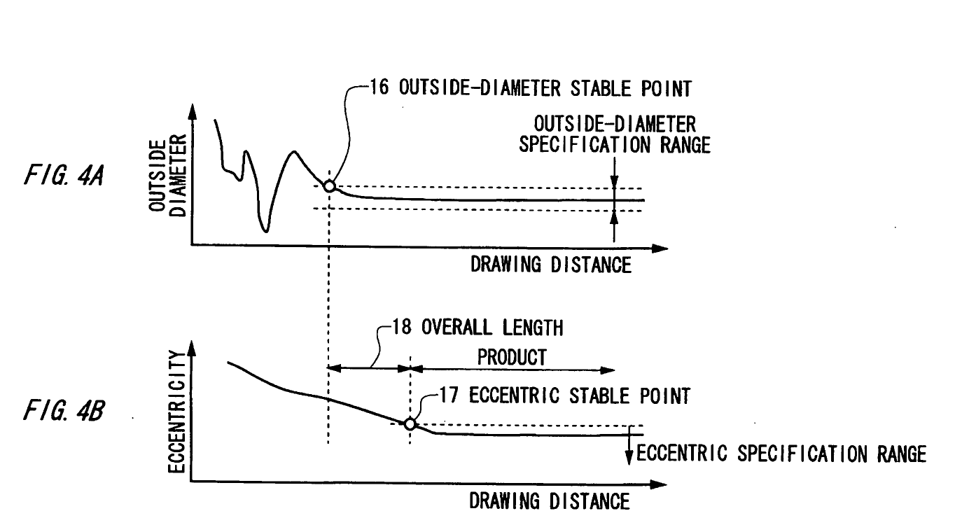

As shown in FIG. 2, a dummy rod 3 is connected to one end of a glass base material for drawing attached to a drawing apparatus and a taper portion 4 is formed on the other end. As a result of committed researches, the present inventor has found that the eccentricity of optical fiber in an early stage of the start of drawing is largely controlled by the shape of the taper portion 4, the eccentricity of optical fiber in an early stage of the start of drawing becomes large according to a degree of distortion and thus excess length 18 shown in FIG. 4 tends to become long, and as a result, yield decreases, when the taper portion 4 has asymmetry for a center line of the glass base material for drawing, in order words when the taper portion 4 includes distortion.

However, although an end of the glass base material is precisely processed by fusing or mechanical grinding, a taper portion without distortion may not be obtained. Thus, as a result of a keen examination, the problem can be solved by measuring a center-line displacement amount (hereinafter, simply referred to as a center-line displacement amount) at a taper portion formation point (a fusing point when being formed by fusing) for a center line of an effective straight base of the glass base material, and fusing and forming the taper portion after modifying the center-line displacement amount to be not more than a predetermined numeric value, before forming the taper portion. In this way, it is possible to immediately reduce and stabilize the eccentricity of optical fiber in an early stage of the start of drawing and shorten excess length.

A method for manufacturing the glass base material of the present invention is to modify a center-line displacement amount at a fusing point for a center line of the glass base material to a value not more than a predetermined numeric value and then fuse the glass base material from the modified point to form the taper portion, and is to fuse the glass base material to form the taper portion after modifying the center-line displacement amount at a fusing point to a value not more than a predetermined numeric value, particularly 2.6 mm before fusing. In this way, it is possible to immediately stabilize the eccentricity of optical fiber in an early stage of the start of drawing to reduce it and shorten excess length. In addition, a fusing point is a point that is a starting end for forming the taper portion.

Moreover, according to the present invention, since the distortion of shape of the taper portion 4 is put in a predetermined number range, a ratio δ/D between distortion δ and an average outside diameter D is δ/D<=0.03.

In this way, it is possible to stably reduce the eccentricity of optical fiber in an early stage of the start of drawing and shorten excess length.

In addition, an end of a straight base of the glass base material for drawing, which is also a starting point of the taper portion, defines a part having an outside diameter made by multiplying a coefficient β by an average outside diameter D. The coefficient β is in a range of 0.90 to 1.00 (no dimension). For example, assuming that β=0.98 and the average outside diameter D=80 mm, the end of straight base is a position reaching an outside diameter=0.98*80=78.4 mm in the vicinity of taper.

The glass base material for drawing including the taper portion is obtained by measuring a ratio δ/D between distortion δ and the average outside diameter D, and a glass base material having distortion exceeding 1.00 mm and a glass base material having δ/D exceeding 0.03 are fused or grinded so as to be put in a predetermined numeric value. The length L_{D} of the taper portion is processed so as to be not less than one time of a mean value D_{M} of the outside diameter. L_{D} less than one time is not preferable because an amount of softening material that does not become a fiber increases at the start of drawing.

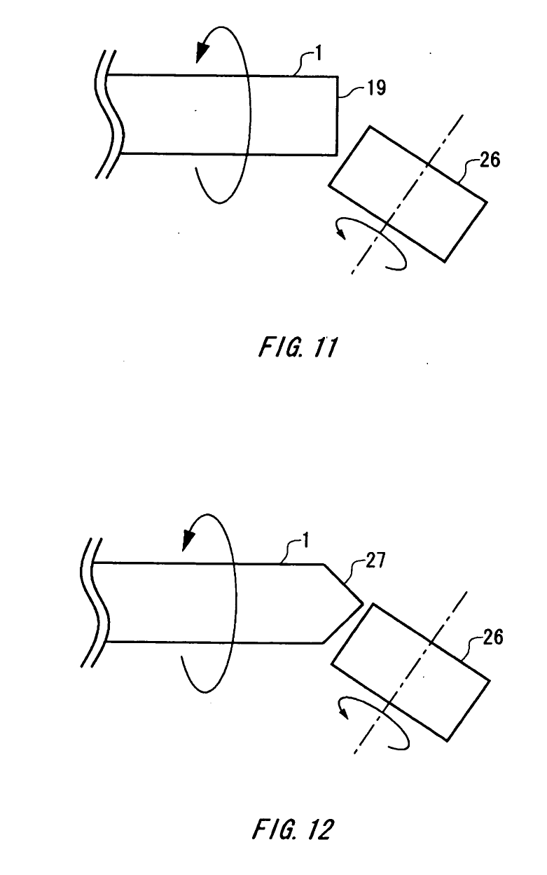

In addition, as shown in FIG. 11, the taper portion of the glass base material for drawing can be formed by grinding. That is to say, as shown in the present drawing, while rotating the glass base material 1 around a shaft in a longitudinal direction, grinding is performed by the rotating rotational grindstone 26 for a mechanical cutting face 19. In this way, a grinding taper portion 27 as shown in FIG. 12 is formed on an end on which the mechanical cutting face 19 was placed. In addition, when forming the grinding taper portion 27 in this method, a rotation axis of the glass base material 1 also becomes an axis of the taper portion.

Moreover, in a method shown in FIG. 12, it is possible to also modify the existing taper portion by grinding. That is to say, as shown in the present drawing, the shape of the grinding taper portion 27 can be modified by further performing grinding by the rotating rotational grindstone 26 for the grinding taper portion 27 that is already formed. In addition, modification can be performed on the fusing taper portion formed by fusing by the combination of different kinds of processing methods such as grinding and so on.

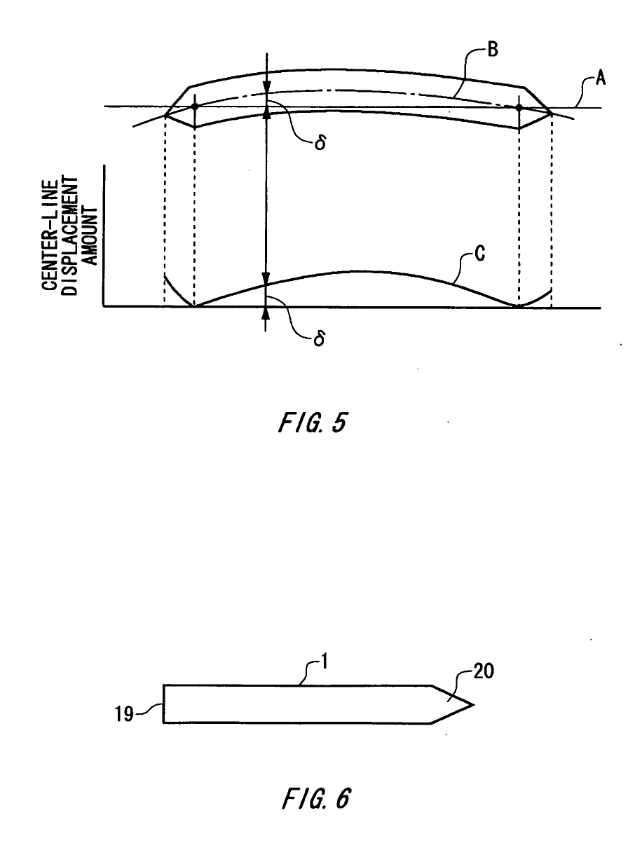

As shown in FIG. 5, distortion 6 is expressed with a displacement amount between a straight line A passing through a center of an effective straight base both ends and a center line B of the glass base material, that is, a center-line displacement amount. A curved line C is a curved line showing a center-line displacement amount along a longitudinal direction of the glass base material. On the other hand, distortion δ of the taper portion is expressed with a maximum value of a center-line displacement amount between the end of straight base and the distortion evaluating end of the taper portion. The distortion evaluating area is an area between the end of straight base and the distortion evaluating end in one taper portion side.

In addition, the end of straight base of the glass base material for drawing is a starting point of the taper portion, and is a part having an outside diameter obtained by multiplying the coefficient δ by the average outside diameter D. Moreover, the coefficient β is in a range of 0.90 to 1.00 (no dimension).

Moreover, the measurement of distortion of the taper portion uses a preform-shaped measuring device for optical fiber disclosed in Japanese Patent No. 3222777, but is not limited to this if it is an apparatus including a similar function. The glass base material for drawing measured and sorted in this way is provided to drawing processing.

FIG. 6 shows a glass base material for drawing having the fusing taper portion 20 fused and formed after modifying a center-line displacement amount at a fusing point to a value not more than 2.6 mm. This glass base material for drawing has an average outside diameter of Φ462 mm and the length of straight base of 1040 mm, has the mechanical cutting face 19 on one end and the fusing taper portion 20 of length L_{D} 77 mm fused and formed on the other end. In addition to an outside diameter and a center-line displacement amount of this glass base material for drawing 1, a shape measuring device measures distortion 6 of the fusing taper portion 20.

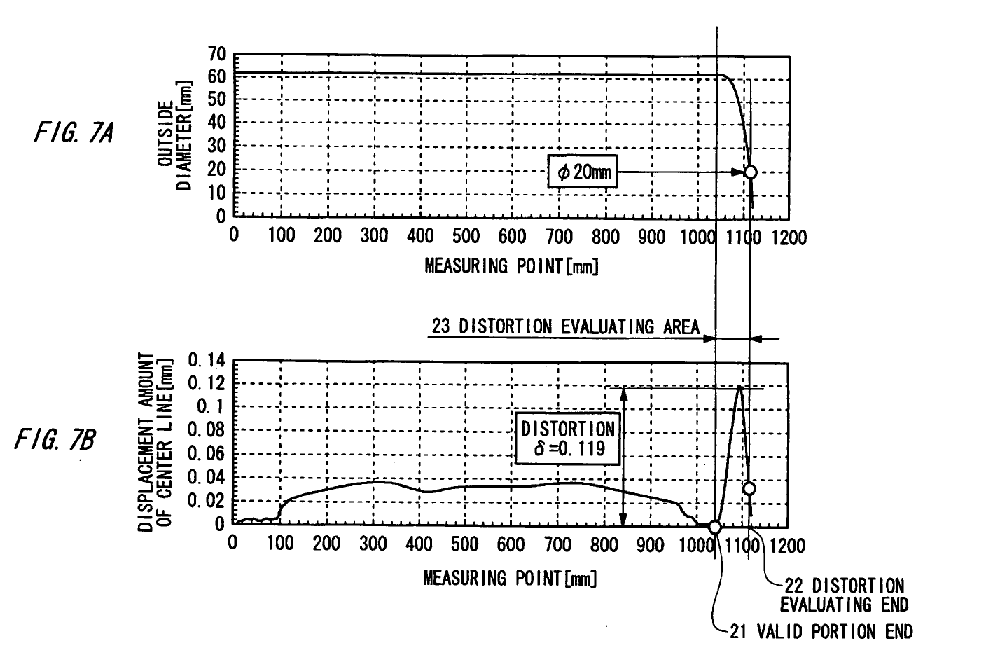

FIGS. 7A and 7B show a measurement result. In addition, this glass base material for drawing may be formed by grinding of the taper portion. FIG. 7A shows the change of outside diameter for a longitudinal direction (horizontal axis) of a glass base material for drawing and FIG. 7B shows the change of a displacement amount of a center line for the longitudinal direction (horizontal axis) of the glass base material for drawing.

The measurement procedure of distortion δ of the fusing taper portion is as follows. First, an end 21 of the straight base of the glass base material and the distortion evaluating end 22 of the fusing taper portion are determined. An outside diameter is measured at five points adjacent to the center at which the outside diameter is comparatively stable, and a mean value D_{M} for outside diameters is obtained. The end 21 of straight base is a portion of the coefficient β=0.98, that is, a position of which an outside diameter is 0.98*D_{M}.

When the glass base material for drawing is attached to a drawing apparatus, the distortion evaluating end 22 is a position equivalent to the center of a heating furnace heating unit and is a position at which an outside diameter of the taper portion is φ20 mm in FIG. 7A, and heating by the drawing apparatus is started at the position at which the outside diameter of the glass base material for drawing is φ20 mm. In FIG. 7B, the distortion δ of the taper portion is extremely small and δ=0.119 mm.

When the formation of taper portion is performed by fusing, the distortion of taper portion largely comes under the influence of a center-line displacement amount of the glass base material before forming the taper portion, particularly, a center-line displacement amount of a taper forming point (a fusing point). Therefore, it is necessary to previously reduce a center-line displacement amount of a fusing point to reduce the distortion of taper portion by fusing. In the present invention, as a result of keen examinations for relation between the center-line displacement amount of fusing point and the distortion of taper portion, there is made clear the center-line displacement amount of fusing point for realizing the distortion not more than a specified value.

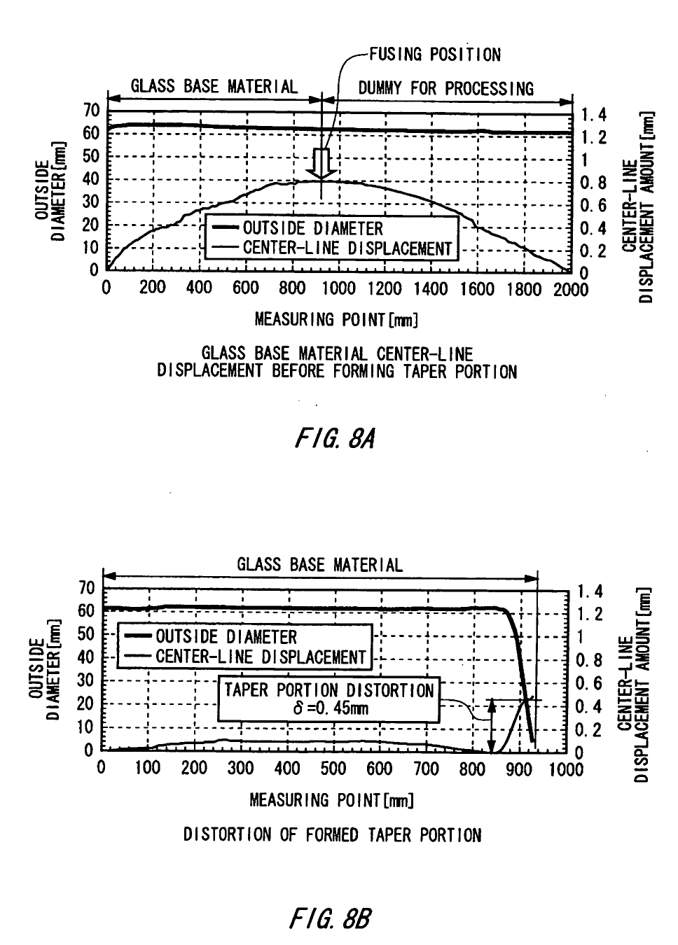

FIGS. 8A and 8B are views exemplary showing a center-line displacement amount of a glass base material before forming a taper portion and distortion of the formed taper portion. FIG. 8A shows an outside diameter and a center-line displacement amount of the glass base material before forming the taper. In this example, the taper portion is formed by fusing at the substantially central position of the glass base material. A left side of a fusing point is a portion that becomes the glass base material for drawing and a right side becomes a dummy rod for processing. Next, FIG. 8B shows a result obtained by measuring a center-line displacement amount of the glass base material for drawing in which the taper portion is formed. The distortion δ of the taper portion at this time becomes δ=0.45 mm according to the above definition, and a ratio δ/D between the distortion δ of the taper portion and the average outside diameter D of the straight base of the glass base material for drawing becomes 0.007 mm.

The distortion δ/D for the average diameter D and the eccentricity of optical fiber have correlativity, and the eccentricity of optical fiber becomes large and the excess length gets longer when the distortion δ/D exceeds 0.03. For this reason, fusing processing is performed once more so as to be put in a predetermined numeric value when δ/D exceeds 0.03.

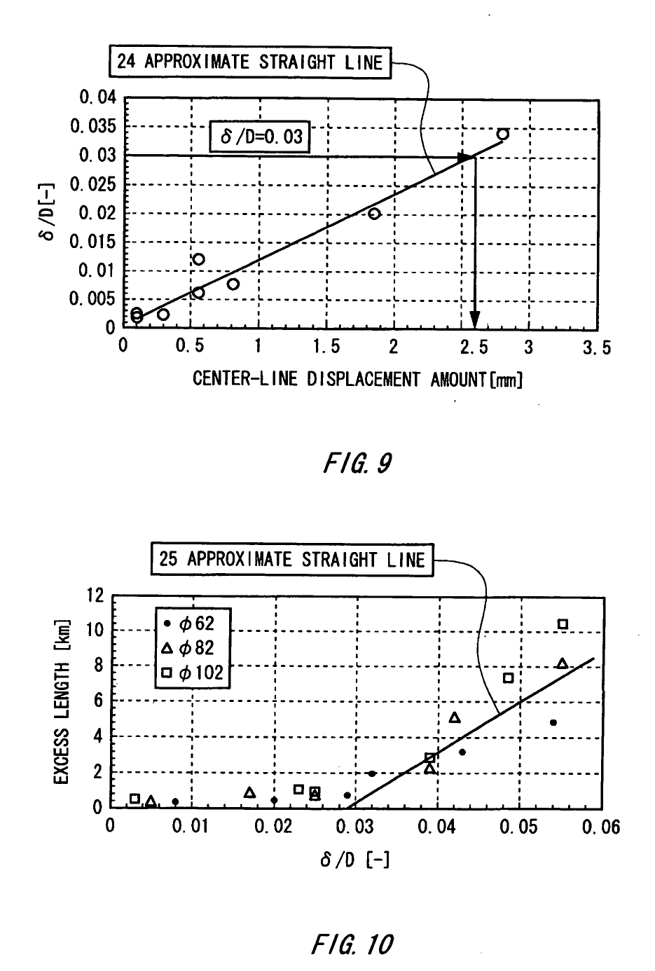

Moreover, FIG. 9 shows correlativity between a center-line displacement amount of a fusing position and distortion of a taper portion formed by fusing. A straight line in the drawing is an approximate straight line 24 obtained by being computing by least squares approximation from each plotting point. From FIG. 8, a center-line displacement amount e satisfying a range of δ/D03 becomes e<=2.6 mm.

When the taper portion is formed by fusing after modifying the glass base material until the center-line displacement amount e<=2.6 mm, it is possible to sufficiently reduce the distortion of taper portion.

### Embodiment 1

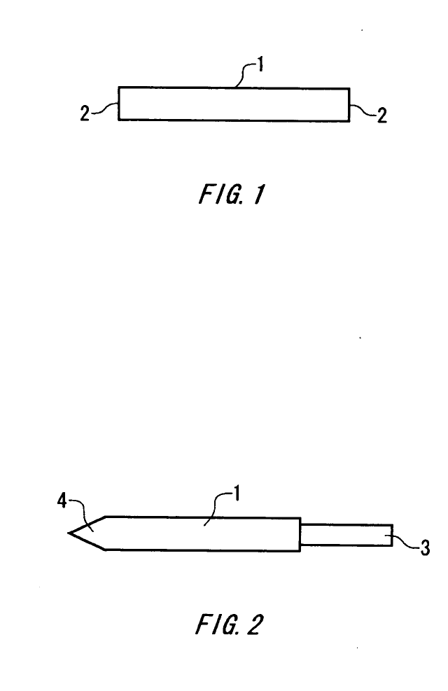

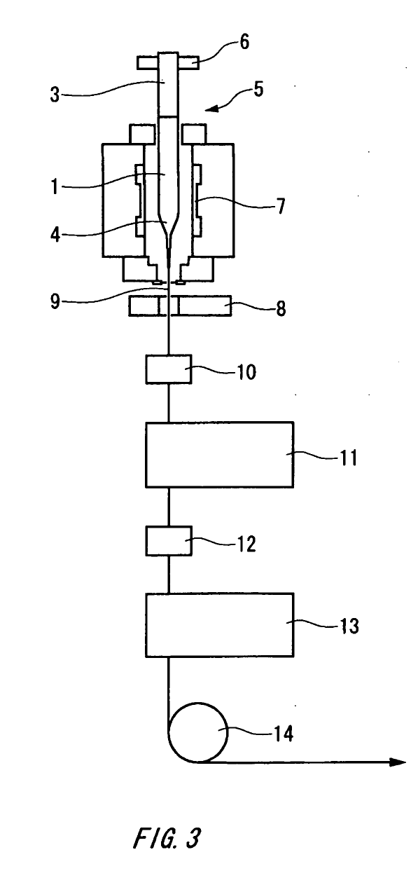

The glass base material is modified so that a center-line displacement amount becomes not more than 2.6 mm by attaching the glass base material of an average outside diameter φ62 mm and length 1100 mm having the mechanical cutting face 2 on both ends to a glass lathe including a shape measuring device as shown in FIG. 1, measuring a center-line displacement amount of the glass base material, and heating and softening the glass base material with a burner flame while rotating the glass base material, when the center-line displacement amount at the fusing point forming the taper portion exceeds 2.6 mm. Next, the glass base material for drawing is formed by fusing the glass base material at the above fusing point and forming the fusing taper portion as shown in FIG. 6.

In the glass base material for drawing, a center-line displacement amount between the end of straight base of which an outside diameter is 0.98*D_{M}=60.8 mm and the distortion evaluating end of which the outside diameter of taper portion is Φ20 mm, that is, the distortion of taper portion is extremely small, and δ=0.119 mm and δ/D=0.002 mm. In this manner, since there is drawn the glass base material for drawing made by sufficiently reducing the distortion of taper portion, it is possible to improve yield when manufacturing an optical fiber and thus reduce manufacturing cost of the optical fiber.

### Embodiment 2

The drawing is performed by preparing several kinds of glass base materials with an outside diameter different from one another and respectively forming taper portions by fusing. FIG. 10 shows relation between a ratio δ/D between distortion δ of the taper portion at that time and the glass base material outside diameter D and excess length of the drawn optical fiber. An approximate straight line 25 in the drawing is obtained by least squares approximation computing for a plotting point in an area in which δ/D>=0.035. From FIG. 10, in a range in which δ/D<=0.03, it can be confirmed that the excess length does not vary almost and extremely becomes small.

### INDUSTRIAL APPLICABILITY

The manufacturing cost of optical fiber can be lowered by using the glass base material obtained in a manufacturing method of the present invention, and this method is extremely valid.

1. A method for fusing a cylindrical glass base material and manufacturing a glass base material for drawing having a straight base with a substantially constant diameter and a taper portion that is formed on one end of the straight base and of which a diameter becomes narrow as the taper portion departs from the straight base, the manufacturing method comprising:
modifying a center-line displacement amount of a fusing point for a center line of an effective straight base of the glass base material to a predetermined numeric value to form a modified point; and
fusing the glass base material at the modified point to form the taper portion.

2. The manufacturing method as claimed in claim 1, wherein the modifying comprises an operation heating the glass base material with a burner flame while rotating the glass base material by a glass lathe.

3. The manufacturing method as claimed in claim 1, wherein the predetermined numeric value is 2.6 mm.

4. The manufacturing method as claimed in claim 1, wherein the fusing comprises an operation heating the glass base material with a burner flame.

5. The manufacturing method as claimed in claim 1, wherein the modified glass base material is attached to a drawing apparatus, and the fusing is performed just before drawing.

6. A glass base material for drawing having a cylindrical straight base and a taper portion formed on one end of the straight base so that a diameter becomes narrow as the taper portion departs from the straight base, wherein
the taper portion is formed by fusing a modified point modified so that a center-line displacement amount for a center line of the whole cylindrical glass base material is less than or equal to a predetermined numeric value.

7. A glass base material for drawing having an effective straight base with an average outside diameter D and a taper portion that is formed on one end of a straight base that is a part of the effective straight base and of which a diameter becomes narrow as the taper portion departs from the straight base, wherein
a ratio δ/D between the average outside diameter D and a taper portion distortion δ is δ/D<=0.03 when the glass base material for drawing is attached to a drawing apparatus and when a maximum value of a displacement amount of a center of the taper portion for a center of the taper portion side end in the straight base is the taper portion distortion δ.

8. The glass base material as claimed in claim 7, wherein the end of the straight base is a part having an outside diameter of a value obtained by multiplying a coefficient β in a range of 0.90 to 1.00 (no dimension) by the average outside diameter D.

9. The glass base material as claimed in claim 7, wherein a length L_{D} of the taper portion is not less than one time of a mean value D_{M} for outside diameters at three to ten points randomly extracted from the vicinity of center in a longitudinal direction of the glass base material in the range of 30 to 60% of overall length of the glass base material.

10. The glass base material as claimed in claim 7, wherein the taper portion is formed by fusing or grinding.

11. A method for manufacturing a glass base material for drawing having a straight base with an average outside diameter D and a taper portion that is formed on one end of the straight base and of which a diameter becomes narrow as the taper portion departs from the straight base, the method comprising
drawing the glass base material for drawing in which a ratio δ/D between the average outside diameter D and a taper portion distortion δ is δ/D<=0.03, when the glass base material for drawing is attached to a drawing apparatus and when a maximum value of a displacement amount of a center of the taper portion for a center of the taper portion side end in the straight base is the taper portion distortion δ.

12. The manufacturing method as claimed in claim 2, wherein the predetermined numeric value is 2.6 mm.

13. The manufacturing method as claimed in claim 2, wherein the fusing comprises an operation heating the glass base material with a burner flame.

14. The manufacturing method as claimed in claim 3, wherein the fusing comprises an operation heating the glass base material with a burner flame.

15. The manufacturing method as claimed in claim 2, wherein the modified glass base material is attached to a drawing apparatus, and the fusing is performed just before drawing.

16. The manufacturing method as claimed in claim 3, wherein the modified glass base material is attached to a drawing apparatus, and the fusing is performed just before drawing.

17. The manufacturing method as claimed in claim 4, wherein the modified glass base material is attached to a drawing apparatus, and the fusing is performed just before drawing.

18. The glass base material as claimed in claim 8, wherein a length L_{D} of the taper portion is not less than one time of a mean value D_{M} for outside diameters at three to ten points randomly extracted from the vicinity of center in a longitudinal direction of the glass base material in the range of 30 to 60% of overall length of the glass base material.

19. The glass base material as claimed in claim 8, wherein the taper portion is formed by fusing or grinding.

20. The glass base material as claimed in claim 9, wherein the taper portion is formed by fusing or grinding.
